(19) United States
(12) Patent Application Publication
(10) Pub. No.: US 2026/0097556 A1
(43) Pub. Date: Apr. 9, 2026

(54) METHODS AND SYSTEMS FOR GENERATING A LIGHT SHEET AND METHODS AND SYSTEMS FOR FORMING ONE OR MORE OBJECTS IN A VOLUME

(71) Applicant: QUADRATIC 3D, INC., CHARLESTOWN, MA (US)

(72) Inventors: KAREN TWIETMEYER, BELMONT, MA (US); ERIK HINRICHSEN, WATERTOWN, MA (US)

(21) Appl. No.: 19/352,445

(22) Filed: Oct. 7, 2025

Related U.S. Application Data
(60) Provisional application No. 63/704,526, filed on Oct. 7, 2024.

(51) Int. Cl. B29C 64/135; B33Y 10/00

(52) U.S. Cl. CPC B29C 64/135; B33Y 10/00

(57) ABSTRACT

The present invention includes methods and systems including at least one aspheric surface for generating a light sheet for producing substantial cure uniformity in a photohardenable composition along the light sheet height. Methods and systems for forming one or more objects in a volume of a photohardenable composition, which methods and systems include such light sheet generating system, are also disclosed.

### CROSS-REFERENCE TO RELATED APPLICATIONS

This application claims priority to U.S. Provisional Patent Application No. 63/704,526 filed on Oct. 7, 2024, which application is hereby incorporated herein by reference in its entirety for all purposes.

### TECHNICAL FIELD OF THE INVENTION

The present invention relates to the field of three-dimensional printing.

### BACKGROUND OF THE INVENTION

In three-dimensional printing methods that include directing a light sheet through a printing resin, there is a decrease in light sheet irradiance (power per area) as the light sheet passes through the printing resin build volume, with the magnitude of the decrease dependent on the absorptance of the resin. If uncompensated, this decrease in irradiance reduces print quality. One method to compensate for the decrease in light sheet irradiance from entrance to exit of build volume (i.e., across the width of the build volume), when, for example, a scanner is used in generating the light sheet, is to convert the diverging fan of light rays from the scanner into a converging fan of light rays, with angular profile determined by the absorptance of the resin. The converging ray bundle has decreasing spatial extent, and thus decreasing area, as it passes through the resin, and this reduction in area fully or partly balances the power reduction due to absorption, in such a way that the irradiance (power/area) does not decrease, or decreases less than it would if the rays were not converging. A method of converting the diverging fan of rays from the scanner to a converging fan of rays is to use one or more light sheet optics (e.g., lenses) that are placed between the scanner and the resin container. However, these light sheet optics impart a redistribution to the angular distribution of the incident rays, with the result that the spatial uniformity of the light sheet irradiance is modified, both along the light sheet height and through the build volume width. As the light sheet height increases to accommodate a larger build volume, or as the angle of the converging ray fan increases to provide more absorption compensation, the height of the light sheet optics also must increase. For light sheet optics consisting of only spherical surfaces, the angular redistribution is such that there is increased irradiance towards the top and bottom of the light sheet, and reduced irradiance towards the center, this effect increasing across the build volume width, and also increasing with light sheet height, which results in nonuniformity when printing, especially for larger build volumes. While this undesirable redistribution of rays could possibly be compensated through angular redistribution of the ray fan that is incident on the light sheet optics (i.e., with a ray source that has denser ray distribution/higher irradiance at lower angles, and sparser ray distribution/lower irradiance at higher angles), this is generally not possible when using a scanner to generate a ray fan. In particular, with the use of most scanner types including polygon, galvanometer, and MEMs, the angular distribution of rays is more dense at higher angles and more sparse at lower angles, so that the irradiance is normally higher at higher angles and lower at lower angles, which is opposite to what would be needed to compensate for the angular redistribution due to spherical light sheet optics.

It would represent an advance to to improve the uniformity of a light sheet irradiance profile for use in volumetric printing involving light sheets and other light sheet applications.

### BRIEF SUMMARY OF THE INVENTION

The present invention includes methods and systems for generating a light sheet and methods and systems for forming one or more objects in a volume of a photohardenable composition for achieving substantially uniform cure along the height of the light sheet as it traverses though the volume of the photohardenable composition.

In accordance with one aspect of the present invention there is provided a method for generating a light sheet having a height for use in three-dimensional printing, the method comprising:
a. generating a light sheet from a light sheet generator including a light source for generating a first wavelength and one or more light sheet generating optical elements for shaping the first light into a light sheet including light rays, and
b. directing the as-generated light sheet including the light rays though an optical system having a light sheet input side and a light sheet output side, wherein the optical system comprises one or more optical elements at least one of which has an aspherical surface designed for converting the light rays into a converging ray fan that provides a light sheet output with absorption compensation as it traverses through the volume of the photohardenable composition for achieving substantially uniform cure along the height of the light sheet along its traversal path through the volume.

In accordance with another aspect of the present invention there is provided a method for generating a light sheet having a height with a profile of power along its height and a profile of thickness along its height throughout the width of the for producing substantial cure uniformity in a photohardenable composition along the light sheet height, the method comprising:
a. generating a light sheet with a light sheet generator including a light source for generating a first wavelength and one or more light sheet generating optical elements for shaping the first light into a light sheet including light rays with an as-generated power profile along its height and an as-generated thickness profile along its height and having a propagation direction, and
b. directing the as-generated light sheet through a light sheet input side of an optical system including the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is substantially uniform over the height of the light sheet, and the as-generated light sheet thickness profile at the light sheet input side to a light sheet output thickness profile at the light sheet output side that is substantially uniform over the light sheet height such that the cure along height is substantially uniform.

The method can preferably further includes directing the light sheet output of the optical system into a container of photohardenable composition, the photohardenable composition having a known absorptivity value for the first wavelength.

Preferably the light rays included in the light sheet output have an angular distribution such that the uniformity of the power profile along the light sheet height is maintained throughout the depth of the photohardenable composition.

Advantageously, such power profile uniformity counters the absorption of light as the light sheet output traverses the depth of the photohardenable composition. The aspherical surface generates such profile without spherical aberrations which are unavoidable in a system using spherical optical elements without an aspherical optical element.

In accordance with one aspect of the present invention there is provided a system for generating a light sheet having a height with a profile of power along its height and a profile of thickness along its height for producing substantial cure uniformity in a photohardenable composition along the light sheet height, the system comprising:
a light sheet generator including a light source for generating a first light and one or more light sheet generating optical elements for shaping the first light into a light sheet with an as-generated power profile along its height and an as-generated thickness power profile along its height and having a propagation direction, and
an optical system including a light sheet input side and a light sheet output side, wherein the optical system comprises one or more optical elements at least one of which has an aspherical surface for converting the as-generated light sheet height power profile at the light sheet input side to a light sheet height power profile at the light sheet output side that is substantially uniform over the height of the light sheet, and the as-generated light sheet thickness profile at the light sheet input side to a light sheet output thickness profile at the light sheet output side that is substantially uniform over the light sheet height such that the cure along height is substantially uniform.

In accordance with another aspect of the present invention there is provided a method for generating a light sheet having a profile of power along its height and a profile of thickness along its height for producing substantial cure uniformity in a photohardenable composition along the light sheet height, the method comprising:
a. generating a light sheet with a light sheet generator including a light source for generating a first light and one or more light sheet generating optical elements for shaping the first light into a light sheet with an as-generated power profile along its height and an as-generated thickness profile along its height and having a propagation direction, and
b. directing the as-generated light sheet through a light sheet input side of an optical system including the light sheet input side and a light sheet output side, wherein the optical system includes the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is non-uniform over the height of the light sheet, and the as-generated light sheet thickness profile at the light sheet input side to a light sheet output thickness profile at the light sheet output side that is non-uniform over the light sheet height such that the cure along height is substantially uniform.

The method can preferably further includes directing the light sheet output of the optical system into a container of photohardenable composition, the photohardenable composition having a known absorptivity value for the first wavelength.

Preferably the light rays included in the light sheet output have an angular distribution such that the uniformity of the power profile along the light sheet height is maintained throughout the depth of the photohardenable composition.

Advantageously, such uniformity counters the absorption of light as the light sheet output traverses the depth of the photohardenable composition. The aspherical surface generates such profile without spherical aberrations which are unavoidable in a system using spherical optical elements without an aspherical optical element.

In accordance with another aspect of the present invention there is provided a system for generating a light sheet having a height with a profile of power along its height and a profile of thickness along its height for producing substantial cure uniformity in a photohardenable composition along the light sheet height, the system comprising:
a light sheet generator including a light source for generating a first light and one or more light sheet generating optical elements for shaping the first light into a light sheet with an as-generated power profile along its height and an as-generated thickness profile along its height and having a propagation direction, and
an optical system including a light sheet input side and a light sheet output side, wherein the optical system comprises one or more optical elements at least one of which has an aspherical surface for converting the as-generated light sheet height power profile at the light sheet input side to a light sheet height power profile at the light sheet output side that is non-uniform over the height of the light sheet, and the as-generated light sheet thickness profile at the light sheet input side to a light sheet output thickness profile at the light sheet output side that is non-uniform over the light sheet height such that the cure along height is substantially uniform.

In accordance with another aspect of the present invention there is provided a method of forming one or more objects in a volume of a photohardenable composition, the method comprising: (a) providing a volume of the photohardenable composition included within a container wherein at least a portion of the container is optically transparent so that the photohardenable composition is accessible by excitation light; (b) directing a light sheet generated by a method for generating a light sheet described herein to one or more selected locations in the volume of the photohardenable composition, and projection of an optical image to the one or more selected locations in the volume of the photohardenable composition to alter at least one property of the photohardenable composition at an intersection of the light sheet and projected optical image at a selected location to induce a crosslinking or polymerization reaction in the photohardenable composition.

In accordance with another aspect of the present invention there is provided a system for forming one or more three-dimensional objects in a volume of a photohardenable composition, the system comprising:
a first optical system comprising a system for generating a light sheet including a system for generating a light sheet described herein, the first optical system being configurable for directing the light sheet to one or more selected locations in the volume of the photohardenable composition contained in a container positioned in the system; and
a second optical system including a second excitation light source, a spatial light modulator and one or more optical elements for illuminating the spatial light modulator and projecting a selected optical image to the one or more selected locations in the volume.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description, from the claims, and from practice of the invention disclosed herein.

### BRIEF DESCRIPTION OF THE DRAWINGS

In the drawings,

FIG. 1 depicts a schematic representation of an optical design including an aspheric curvature on one lens.

FIG. 2 schematically depicts light sheet ray paths though a container (shown as a cuvette).

FIG. 3A displays a graph of relative power versus (vs) distance along a light sheet height for an optical design including at least one lens having an aspheric surface.

FIG. 3B displays a graph of relative power vs. distance along light sheet height for an optical design using spherical lenses.

FIG. 4 presents a flow chart for determining the effective cure profile for the case where the profiles of power vs. height and thickness vs. height have non-uniform profiles.

FIG. 5A depicts an example of a light sheet power profile graph for a light sheet generated without use of an aspheric surface; FIG. 5B depicts an example of a light sheet thickness profile graph for a light sheet generated without use of an aspheric surface; and FIG. 5C depicts an example of normalized profiles of power, thickness, and effective cure without use of an aspheric surface, showing that the effective cure over height is nonuniform in this case where aspheric optics are not used.

FIG. 6A depicts an example of a light sheet power profile graph for a light sheet generated with use of an aspheric surface; FIG. 6B depicts an example of a light sheet thickness profile graph for a light sheet generated with use of an aspheric surface; and FIG. 6C depicts an example of normalized profiles of power, thickness, and effective cure with use of an aspheric surface, showing that the effective cure over height is uniform in this case where aspheric optics are used.

FIG. 7 is a schematic illustration of a side view of an example of a printing system and method in accordance with the present invention including a light sheet generating system described herein.

The attached figures are simplified representations presented for purposes of illustration only; the actual structures may differ in numerous respects, particularly including the relative scale of the articles depicted and aspects thereof.

For a better understanding to the present invention, together with other advantages and capabilities thereof, reference is made to the following disclosure and appended claims in connection with the above-described drawings.

### DETAILED DESCRIPTION OF THE INVENTION

Various aspects and embodiments of the present inventions will be further described in the following detailed description.

The present invention includes methods and systems for generating a light sheet and methods and systems for forming one or more objects in a volume of a photohardenable composition for achieving substantially uniform cure along the height of the light sheet as it traverses though the volume of the photohardenable composition.

In accordance with one aspect of the present invention there is provided a method for generating a light sheet having a height for use in three-dimensional printing, the method comprising:
a. generating a light sheet from a light sheet generator including a light source for generating a first wavelength and one or more light sheet generating optical elements for shaping the first light into a light sheet including diverging rays, and
b. directing the as-generated light sheet including the diverging rays though an optical system having a light sheet input side and a light sheet output side, wherein the optical system comprises one or more optical elements at least one of which has an aspherical surface designed for converting diverging rays into a converging ray fan that provides a light sheet output with absorption compensation as it traverses through the volume of the photohardenable composition for achieving substantially uniform cure along the height of the light sheet along its traversal path through the volume.

In accordance with another aspect of the present invention there is provided a method for generating a light sheet having a height with a profile of power along its height and a profile of thickness along its height throughout the width of the for producing substantial cure uniformity in a photohardenable composition along the light sheet height, the method comprising:
a. generating a light sheet with a light sheet generator including a light source for generating a first wavelength and one or more light sheet generating optical elements for shaping the first light into a light sheet including light rays with an as-generated power profile along its height and an as-generated thickness profile along its height and having a propagation direction, and
b. directing the as-generated light sheet through a light sheet input side of an optical system including the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is substantially uniform over the height of the light sheet, and the as-generated light sheet thickness profile at the light sheet input side to a light sheet output thickness profile at the light sheet output side that is substantially uniform over the light sheet height such that the cure along height is substantially uniform.

The method can preferably further includes directing the light sheet output of the optical system into a container of photohardenable composition, the photohardenable composition having a known absorptivity value for the first wavelength.

Preferably the light rays included in the light sheet output have an angular distribution such that the uniformity of the power profile along the light sheet height is maintained throughout the depth of the photohardenable composition.

Advantageously, such uniformity counters the absorption of light as the light sheet output traverses the depth of the photohardenable composition. The aspherical surface generates such profile without spherical aberrations which are unavoidable in a system using spherical optical elements without an aspherical optical element.

In accordance with one aspect of the present invention there is provided a system for generating a light sheet having a height with a profile of power along its height and a profile of thickness along its height for producing substantial cure uniformity in a photohardenable composition along the light sheet height, the system comprising:
a light sheet generator including a light source for generating a first light and one or more light sheet generating optical elements for shaping the first light into a light sheet with an as-generated power profile along its height and an as-generated thickness power profile along its height and having a propagation direction, and
an optical system including a light sheet input side and a light sheet output side, wherein the optical system comprises one or more optical elements at least one of which has an aspherical surface for converting the as-generated light sheet height power profile at the light sheet input side to a light sheet height power profile at the light sheet output side that is substantially uniform over the height of the light sheet, and the as-generated light sheet thickness profile at the light sheet input side to a light sheet output thickness profile at the light sheet output side that is substantially uniform over the light sheet height such that the cure along height is substantially uniform.

In accordance with another aspect of the present invention there is provided a method for generating a light sheet having a profile of power along its height and a profile of thickness along its height for producing substantial cure uniformity in a photohardenable composition along the light sheet height, the method comprising:
a. generating a light sheet with a light sheet generator including a light source for generating a first light and one or more light sheet generating optical elements for shaping the first light into a light sheet with an as-generated power profile along its height and an as-generated thickness profile along its height and having a propagation direction, and
b. directing the as-generated light sheet through a light sheet input side of an optical system including the light sheet input side and a light sheet output side, wherein the optical system includes the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is non-uniform over the height of the light sheet, and the as-generated light sheet thickness profile at the light sheet input side to a light sheet output thickness profile at the light sheet output side that is non-uniform over the light sheet height such that the cure along height is substantially uniform.

The method can preferably further includes directing the light sheet output of the optical system into a container of photohardenable composition, the photohardenable composition having a known absorptivity value for the first wavelength.

Preferably the light rays included in the light sheet output have an angular distribution such that the uniformity of the power profile along the light sheet height is maintained throughout the depth of the photohardenable composition.

Advantageously, such uniformity counters the absorption of light as the light sheet output traverses the depth of the photohardenable composition. The aspherical surface generates such profile without spherical aberrations which are unavoidable in a system using spherical optical elements without an aspherical optical element.

In accordance with another aspect of the present invention there is provided a system for generating a light sheet having a height with a profile of power along its height and a profile of thickness along its height for producing substantial cure uniformity in a photohardenable composition along the light sheet height, the system comprising:
a light sheet generator including a light source for generating a first light and one or more light sheet generating optical elements for shaping the first light into a light sheet with an as-generated power profile along its height and an as-generated thickness profile along its height and having a propagation direction, and
an optical system including a light sheet input side and a light sheet output side, wherein the optical system comprises one or more optical elements at least one of which has an aspherical surface for converting the as-generated light sheet height power profile at the light sheet input side to a light sheet height power profile at the light sheet output side that is non-uniform over the height of the light sheet, and the as-generated light sheet thickness profile at the light sheet input side to a light sheet output thickness profile at the light sheet output side that is non-uniform over the light sheet height such that the cure along height is substantially uniform.

In accordance with another aspect of the present invention there is provided a method of forming one or more objects in a volume of a photohardenable composition, the method comprising: (a) providing a volume of the photohardenable composition included within a container wherein at least a portion of the container is optically transparent so that the photohardenable composition is accessible by excitation light; (b) directing a light sheet generated by a method for generating a light sheet described herein to one or more selected locations in the volume of the photohardenable composition, and projection of an optical image to the one or more selected locations in the volume of the photohardenable composition to alter at least one property of the photohardenable composition at an intersection of the light sheet and projected optical image at a selected location to induce a crosslinking or polymerization reaction in the photohardenable composition.

In accordance with another aspect of the present invention there is provided a system for forming one or more three-dimensional objects in a volume of a photohardenable composition, the system comprising:
a first optical system comprising a system for generating a light sheet including a system for generating a light sheet described herein, the first optical system being configurable for directing the light sheet to one or more selected locations in the volume of the photohardenable composition contained in a container positioned in the system; and
a second optical system including a second excitation light source, a spatial light modulator and one or more optical elements for illuminating the spatial light modulator and projecting a selected optical image to the one or more selected locations in the volume.

The foregoing and other aspects of the invention described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

In three-dimensional printing techniques that include, for example, exposure of a printing resin (also referred to herein as a photohardenable composition or resin) to two or more excitation lights, a light sheet having a height with a profile of power along its height and a profile of thickness along its height for producing substantial cure uniformity in a photohardenable composition along the light sheet height can be advantageous.

While not wishing to be bound by theory, the relationship between cure and light sheet thickness may be-linear, e.g., double the thickness doubles the cure, or it may be nonlinear. Similarly, the relationship between cure and power may or may not be linear with light sheet power. Because light sheet thickness and light sheet power can both vary along the height of the light sheet with different profiles, and each of the thickness and power profiles can affect cure to different degrees, cure can similarly vary along the height of the light sheet.

In the present invention, inclusion of an aspheric surface can take as input a light sheet with a variable power vs. height profile and/or a variable thickness vs. height profile and produce a light sheet that has a combination of power vs. height profile and thickness vs. height profile that will jointly give a uniform cure vs. height.

In one aspect of the present invention, a light sheet system including an aspheric surface can provide a uniform power vs. height, and simultaneously provide a uniform thickness vs. height. In this case, the cure will be uniform over height regardless of the specific relationship between light sheet power and cure and the specific relationship between light sheet thickness and cure.

In another aspect of the present invention, a light sheet system including an aspheric surface can provide a nonuniform power vs. height and an aspheric surface to provide a nonuniform thickness over height, with the power profile and the thickness profile complementing each other such that the overall cure is uniform (for example, where power is lower the thickness may be narrower or wider as needed to provide a uniform cure).

The present invention is particularly useful for taller light sheets, for example, greater than 25 mm height, in which, for example, the power profile along height may become substantially nonuniform due to non-idealities in the light sheet generating optical system. In this case an aspheric surface design that corrects power non-uniformities would be used.

The present invention is particularly useful for light sheets with short depth of focus, for example, <10 mm depth of focus, in which, for example, the thickness profile along height may become substantially nonuniform due to non-idealities in the light sheet generating optical system. In this case, an aspheric surface design that corrects thickness non-uniformities would be used.

Short light sheets, for example, less than 25 mm, may have a substantially uniform power vs. height as-generated, and in such case, inclusion of an aspheric surface to correct power non-uniformities may not be called for. Long depth of focus light sheets, for example, greater than 10 mm, may have a substantially uniform thickness vs. height as-generated, and in such case, inclusion of an aspheric surface to correct thickness non-uniformities may not be called for. If, however, either a power profile or thickness profile is not uniform, one or more aspheric surfaces may be included to address the nonuniformity.

The above discussion can apply to a light sheet either with or without compression. The design method is the same, but the design requirements are different. If no compression, the rays out of the light sheet generating optical system are parallel to the propagation direction (substantially collimated). If with compression, the rays out of the light sheet generating optical system are converging at an appropriately determined range of angles to compensate for absorption in the photohardenable composition.

In use of a light sheet in printing, the amount of cure depends on both light sheet power and light sheet thickness;

Cure vs. height depends on light sheet power vs. height and light sheet thickness vs. height. In general, when power is higher there is more cure and where thickness is greater there is more cure.

Depending on the printing resin, thickness can have a stronger or weaker effect on cure than power.

For example, cure increase can be 1:1 with thickness (doubling thickness doubles cure).

For example, cure increase can be less than 1:1 with power (doubling power less than doubles cure).

An effectiveness constant can be used to handle this issue for optical design purposes. For example, for the examples above:
Thickness effectiveness constant is 1.
Cure effectiveness constant is <1 (for example, it may be around 0.5).

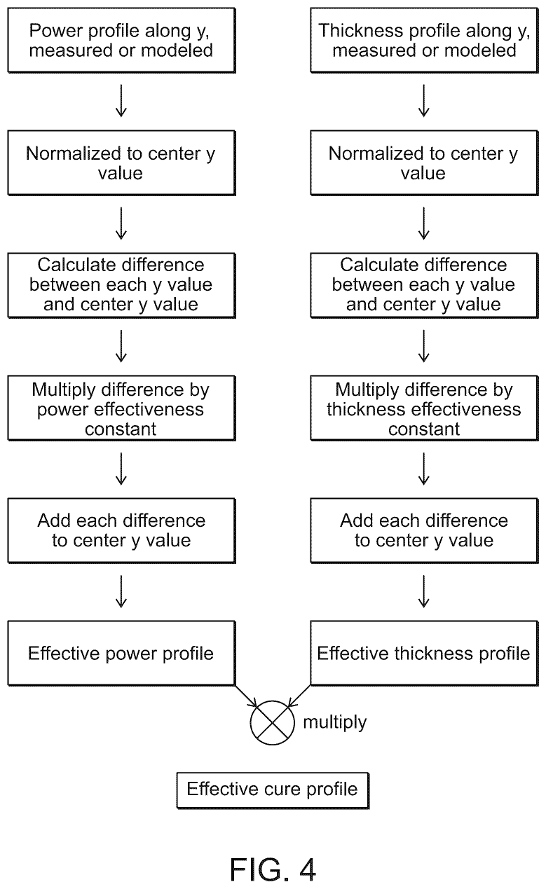

If power and thickness are to be adjusted to give a better cure uniformity vs. height, it is useful to utilize the concept of the effectiveness constants in order to generate an appropriate optical design to give uniform cure. An example of a flow diagram of the steps in a methodology for non-uniform profiles is outlined in FIG. 4. If power profile and thickness profile are uniform, then cure profile will be uniform and this methodology may be optional. If, on the other hand, power profile and/or thickness profile is not uniform, then both profiles can be adjusted to give a uniform cure profile. The following figures specifically refer to methods supportive of determining the effectiveness constants.

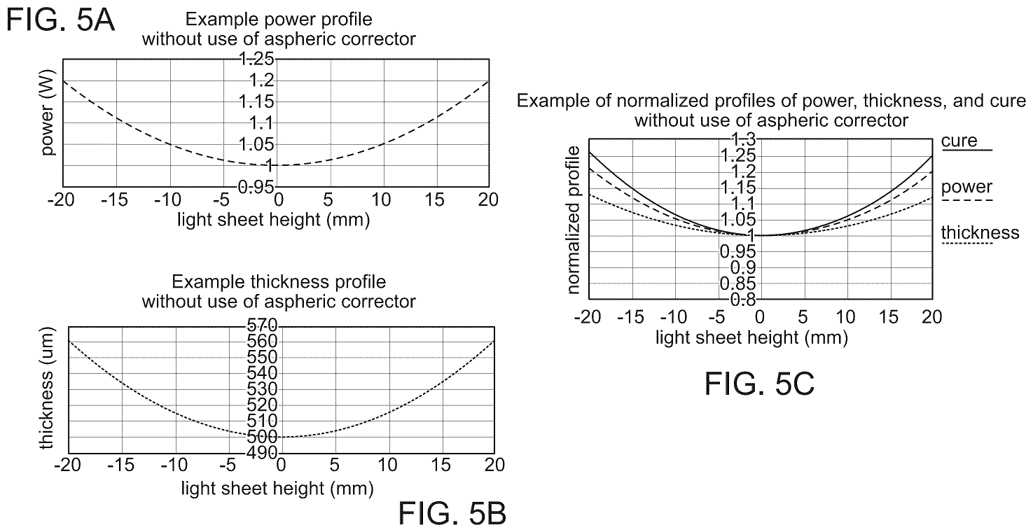

FIGS. 5A-5C relate to an example showing the cure produced with the as-generated light sheet power and thickness profiles, i.e., without an aspheric surface, and in which cure is nonuniform.

FIG. 5A shows an example of light sheet height (mm) vs. power (W). Without an aspheric surface, power varies from 1 W to 1.2 W over the height of the build volume.

FIG. 5B shows an example of light sheet height (mm) vs. thickness (W). Without an aspheric surface, thickness varies from 500 microns to 560 microns over the height of the build volume.

FIG. 5C shows an example of normalized profiles of power, thickness, and cure without use of an aspheric surface, showing a nonuniform cure (An aspheric surface is referred to in the FIG. and may also be referred to elsewhere herein an “aspheric corrector”).

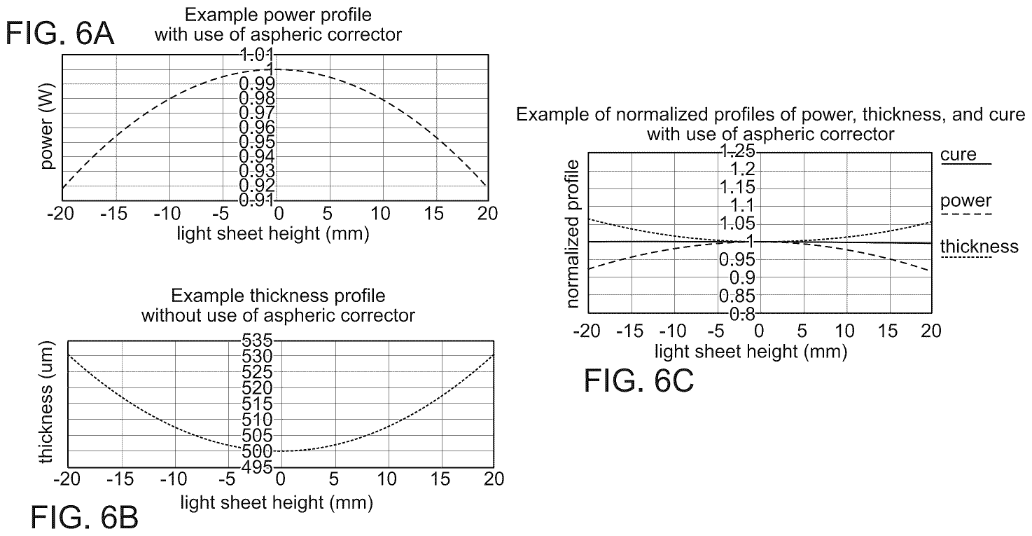

FIGS. 6A-6C relate to an example showing the cure produced with use of one or more aspheric surfaces. (For these examples, the following effectiveness constants were assumed: Power effectiveness constant=0.65, Thickness effectiveness constant=0.9.)

FIG. 6A shows an example of light sheet height (mm) vs. power (W). With an aspheric surface, power varies from 1 W to 0.92 W over the height of the build volume.

FIG. 6B shows an example of light sheet height (mm) vs. thickness (W). With an aspheric surface, thickness varies from 500 microns to 530 microns over the height of the build volume.

FIG. 6C shows an example of normalized profiles of power, thickness, and cure with use of an aspheric surface. (An aspheric surface is referred to in the FIG. and may also be referred to elsewhere herein an “aspheric corrector”), showing that the nonuniform profiles of power and thickness vs. height, taking into account the cure effectiveness constants, produces a uniform cure. The curve for cure over height is uniform because the power and thickness profiles work together to provide such result.

For the examples depicted in FIGS. 6A-6C, the power effectiveness constant=0.65 and the thickness effectiveness constant=0.9.

In accordance with another aspect of the present invention there is provided a system for forming one or more three-dimensional objects in a volume of a photohardenable composition, the system comprising:
a first optical system comprising a system for generating a light sheet having a height with a profile of power along its height and a profile of thickness along its height described herein, the first optical system being configurable for directing the light sheet to one or more selected locations in the volume of the photohardenable composition contained in a container positioned in the system; and
a second optical system including a second excitation light source, a spatial light modulator and one or more optical elements for illuminating the spatial light modulator and projecting a selected optical image to the one or more selected locations in the volume.

The system is preferably further configured to include a container for including the volume of the photohardenable composition. The container preferably includes at least one or more portions that are optically transparent so that the photohardenable composition is accessible by excitation light. A container can optionally be included as a component of the system or can be separately supplied. In either case, it can be desirable for the container to be removable from the system. It can further be desirable for the container to be reusable.

In accordance with another aspect of the present invention there is provided a method of forming one or more objects in a volume of a photohardenable composition, the method comprising: (a) providing a volume of the photohardenable composition included within a container wherein at least a portion of the container is optically transparent so that the photohardenable composition is accessible by excitation light; (b) directing a light sheet generated with a system for generating a light sheet having a height with a profile of power along its height and a profile of thickness along its height described herein to one or more selected locations in the volume of the photohardenable composition, and projection an optical image to the one or more selected locations in the volume of the photohardenable composition to alter at least one property of the photohardenable composition at an intersection of the light sheet and projected optical image at a selected location to induce a crosslinking or polymerization reaction in the photohardenable composition,

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description, from the claims, and from practice of the invention disclosed herein.

### EXAMPLES

The examples provided below are provided as examples, and not limitations.

The following section outlines an example of steps for determining an aspheric surface for converting an as-generated light sheet to light sheet that is substantially uniform over the height and width of the light sheet.

### Steps for Determination of Aspheric Surface(s)

Step 1: select a light source and the means to generate a ray fan from that light source.
A light source may, for example, be a laser, an LED, a VCSEL, an LED array, a VCSEL an array, lamp, etc.
A ray fan may be generated using a scanner (for example, galvo, polygon, MEMS, acousto-optic, electro-optic); Powell lens; Cylindrical lens; 1D SLM or one row or column of 2D SLM; array of sources).
Ray fan may be collimated, converging, or diverging.

Step 2: design an optical system that takes as input the ray fan from Step 1 and produces a ray fan having the following desired properties for the rays when in the region of the build volume depth: heights (e.g., y dimension), ray angles along propagation axis (e.g., propagation in x), and thickness (e.g., z dimension)

Step 3: Accurately model the systems of Step 1 and Step 2 in optical design software, preferably using real data from the build and test of the systems from Step 1 and Step 2 to refine the accuracy of the model

The following additional steps may optionally be included.

For example, the following (a) steps can be added for the case where an aspheric surface is determined to give uniform a power profile, and independently, an aspheric surface is found to give a uniform thickness profile.

Step 4a: In the optical software model, set at least one surface of the Step 2 system to be an aspheric type along the height direction (y), or otherwise insert a new element into the Step 2 system that is aspheric type along the height direction (y). Set the curvature and aspheric constants of the aspheric optical surface to be variable. Optionally set the curvatures of one or more of the other optical surfaces to be variable. Optionally set the distances between one or more of the optical elements to be variable. Optionally set the thicknesses of one or more of the optical elements to be variable. The selection process for constants, curvatures, distances, and thicknesses that are to be varied is well known by those experienced in the art.

Step 5a: In the optical software model, create a metric consisting of uniform power along height at one or more yz planes across the depth of the build volume within the container. If system is designed for compression, include in the metric the desired relative heights of the light sheet at the selected planes of the build volume (height will decrease from entrance to exit plane to balance resin absorption as explained in previous filing).

Step 6a: In the optical software model, run a Monte Carlo simulation such that the variables established in Step 4a are adjusted until the power profile along height comes closest to achieving the metric established in Step 5a. It may be necessary to repeat Steps 4a, 5a, and 6a with different choices for which surface has the aspheric curvature.

Repeat Steps 4a, 5a, and 6a with a surface having a curvature along the thickness (z) direction that varies according to an aspheric function in the height (y) direction, and with a metric that will provide uniform thickness along height, for example, a metric consisting of focus in the z direction as a function of y.

If the design including the one or more chosen aspheric surfaces as determined using the above steps has improved cure uniformity vs. height over an original design without aspheric surfaces, then the new design is successful. If not, Steps 4-6 should be repeated with different selections for the one or more aspheric surfaces.

The following (b) steps can be added for the case where aspheric surfaces for a nonuniform power profile and a nonuniform thickness profile that complement each other such as to give a uniform cure profile are determined simultaneously.

Step 4b: In the optical software model, set at least one surface of the Step 2 system to be an aspheric type along the height direction (y), or otherwise insert a new element into the Step 2 system that is aspheric type along the height direction (y). Set at least one surface of the Step 2 system to have a curvature along the thickness direction (z) that varies according to an aspheric function in the height (y) direction, or otherwise insert a new element into the Step 2 system that have a curvature along the thickness direction (z) that varies according to an aspheric function in the height (y) direction. Set the curvatures and aspheric constants of the aspheric optical surfaces to be variable. Optionally set the curvatures of one or more of the other optical surfaces to be variable. Optionally set the distances between one or more of the optical elements to be variable. Optionally set the thicknesses of one or more of the optical elements to be variable.

Step 5b: In the optical software model, create a metric consisting of uniform cure function along height at both the entrance and exit planes of the build volume; where the cure function along height consists of the product of the effective power profile and the effective thickness profile as described in the FIG. 4. If system is designed for compression, include in the metric the desired relative heights of the light sheet at selected planes within the build volume (height will decrease from entrance to exit plane to balance resin absorption).

Step 6b: In the optical software model, run a Monte Carlo simulation such that the variables established in Step 4b are adjusted until the power profile along height comes closest to achieving the metric established in Step 5b. It may be necessary to repeat Steps 4b, 5b, and 6b with different choice for which surface(s) have the aspheric curvatures.

If the design including the two chosen aspheric surfaces as determined using the above steps has improved cure uniformity vs. height over an original design without aspheric surfaces, then the new design is successful. If not, Steps 4-6 should be repeated with different selections for the one or more aspheric surfaces.

Optical software options in which the steps of this example may be executed include Zemax, Code V, LightTools, TracePro, and FRED, and the like.

### Example of a System

Example of a light sheet generating system may include several components. Such system may include, for example, a laser source with a wavelength in the range 375-425 nm and a power in the range 1-2 Watts. System may include a means of generating a ray fan over light sheet height including a galvanometer with a diverging ray fan in the range +/−5-10 degrees. System may include a means of converting the diverging ray fan to a collimated or converging ray fan in the region of the photohardenable composition container including one or more positive cylindrical lenses with a range of focal lengths in the range +25-250 mm. System may include a means of providing variable focus of the light sheet thickness into the photohardenable composition including a positive cylindrical lens with a focal length in the range +100 mm to +200 mm and a negative cylindrical lens with a focal length in the range −100 mm to −200 mm.

System variables that are to be considered when performing the above optical design steps include: light sheet wavelength, power, and thickness; build volume dimensions; resin container dimensions and refractive index; desired amount of compression (converging ray angles through resin); resin refractive index; and effectiveness constants for power and thickness vs. cure.

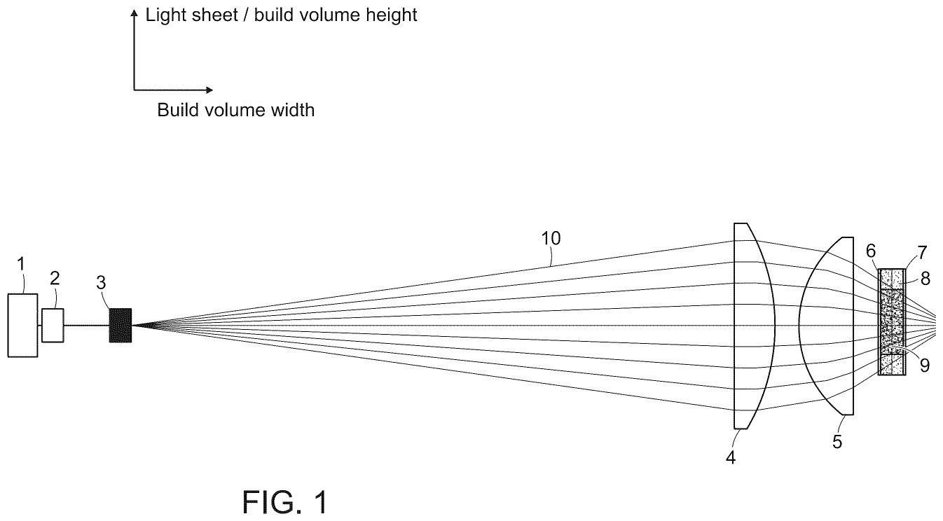

FIG. 1 is a schematic representation of an example of an optical design including aspheric curvature on one lens. Unless otherwise specified, an aspheric surface can be included on a lens and/or mirror included in an optical design.

The depicted optical design includes a light source 1, light sheet generating optics 2, a scanner 3 for generating the as-generated light sheet and first and second optical elements 4, 5 through which the as-generated light sheet passes before entering the light sheet entry side 6 of the container 7 including a printing resin 8. The portion of the volume 9 in which printing takes place (also may also be referred to herein as build volume) is also shown. Representative rays 10 from the scanner, which, as shown, have equal angular spacing are also shown.

As depicted, the first optical element 4 includes an aspherical surface and the second optical element includes a spherical surface. In the Fig., the aspherical and spherical surfaces face each other, with the as-generated light sheet passing through the first optical element before passing into the second optical element.

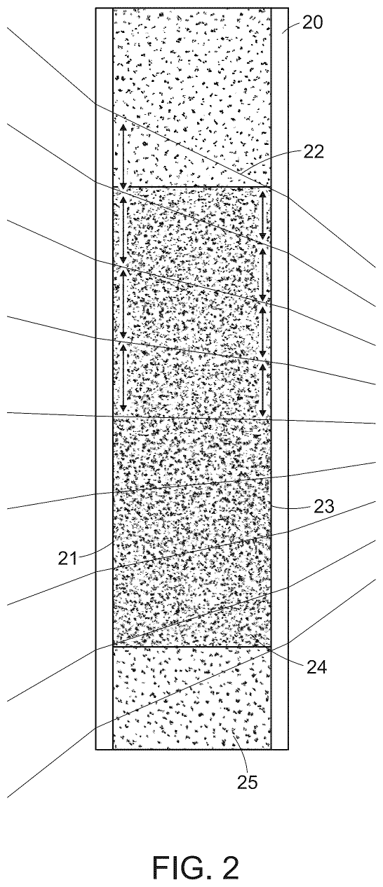

FIG. 2 is a schematic representation of a close-up of an example of ray paths through the container 20 (identified in the FIG. as a cuvette). The aspheric curvature is preferably selected such that rays with known angular spacing from the scanner system generate rays with equal spatial spacing within the container, throughout the width of the build volume. In the FIG., lines with 2 arrowheads indicate rays at the build volume entrance plane 21. As shown, the rays have equal spacing at entrance to build volume. Lines with arrowheads at the build volume exit plane indicate rays exiting the build volume 23. As shown, those rays have equal spacing at exit from build volume. As shown, rays exiting from the build volume are shorter than at entrance, demonstrating absorption compensation due to a smaller area of the build volume from where they exit than from where they enter. The angle of ray 22 is indicative of the level of absorption compensation. In the Figure, the build volume 24 is indicated by darker shading than the volume of printing resin 25 in the container.

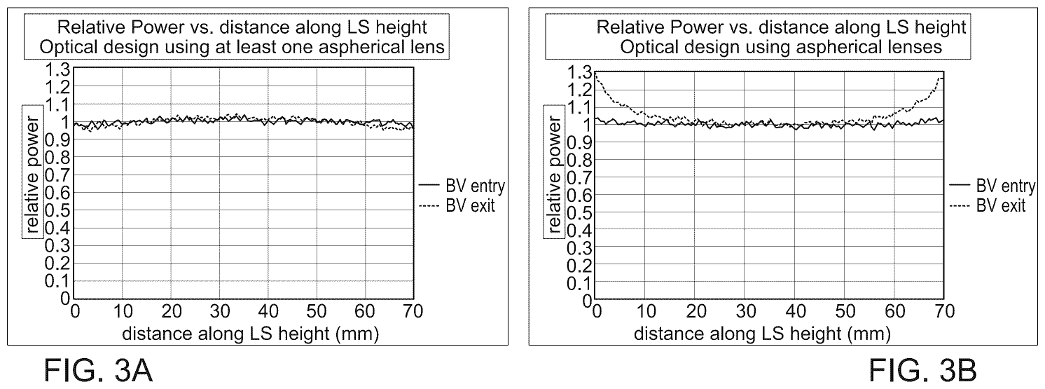

FIGS. 3A and 3B show a simulation of the performance of an aspheric optical system vs. a spherical optical system. The simulation shows relative power vs. distance along light sheet height for the two systems. FIG. 3A represents an aspherical system in which entry and exit to build volume have uniform power along height of light sheet (e.g., within 5%). FIG. 3B represents a spherical optical system in which exit from build volume has substantially more nonuniform power along height of light sheet (e.g., 30%). (The simulations of the depicted aspherical and spherical designs have the same amount of absorption compensation, and the same build volume width and height.)

Examples of printing resins (also referred to as photohardenable composition or resins) for use in the methods described herein include, but are not limited to. can comprise any resin (e.g., a monomer, an oligomer, a pre-polymer, a polymer, or a mixture including at least one the foregoing) that is photohardenable by exposure to light in the presence of a photoinitiator. Examples of photohardenable resin components useful for inclusion in the photohardenable composition include ethylenically unsaturated compounds and, more specifically, a polyethylenically unsaturated compounds. These compounds include both monomers having one or more ethylenically unsaturated groups, such as vinyl or allyl groups, and polymers having terminal or pendant ethylenic unsaturation. Such compounds are well known in the art and include, but are not limited to, acrylic and methacrylic esters of polyhydric alcohols such as trimethylolpropane, pentaerythritol, and the like; and acrylate or methacrylate terminated epoxy resins, acrylate or methacrylate terminated polyesters, etc. Representative examples include, but are not limited to, ethylene glycol diacrylate, ethylene glycol dimethacrylate, trimethylolpropane triacrylate (TMPTA), pentaerythritol tetraacrylate, pentaerythritol tetramethacrylate, dipentaerythritol hydroxypentacrylate (DPHPA), hexanediol-1,6-dimethacrylate, and diethyleneglycol dimethacrylate. Preferred examples include, but are not limited to, a urethane acrylate or a urethane methacrylate-based oligomers. Commercially available examples include, but are not limited to, the following: BRC4421, BRC4421M, BR5825130, BR541MB, BR843D, BR443D, BR741MD1, BR741, BR952, etc. from Bomar; Genomer 4247, Genomer 4259, Genomer 7244, etc. from RAHN; CN9009, CN1964, CN1968, CN1970, etc. from Sartomer.

A photohardenable resin component can optionally comprise one or more multifunctional acrylate monomers. Dipentaerythritol pentaacrylate, a pentafunctional acrylic monomer available from Sartomer as SR399 is an example of a photohardenable resin component that may be desirable for inclusion in the photohardenable composition of the present invention.

Aliphatic urethane acrylates may also be desirable for use as a photohardenable resin component for inclusion in the photohardenable composition described herein.

Mixtures of multifunctional acrylate monomers, such as dipentaerythritol pentaacrylate (e.g., SR399 from Sartomer), and aliphatic urethane acrylates can also be used.

A photohardenable resin component including other mixtures including one or more resin components can also be useful.

It is desirable that the photohardenable resin component included in a photohardenable composition described herein be selected to achieve an optically transparent medium, which is important in processes in which light, e.g., excitation light, is directed into the composition or light.

Examples of photohardenable resin components include, but are not limited to, free-radical-polymerizable resins, cross-linkable resins, multifunctional acrylate monomers, methacrylates, aliphatic urethane acrylates, and the like.

Other examples of photohardenable resin components include a di- or multifunctional oligomer with (meth)acrylate, vinylester, vinylcarbonate, and a backbone of the polymers bearing urethane, urea, amide, bisphenols, epoxies, carbonates, ethers, and esters. The photohardenable composition may optionally include a di- or multifunctional diluents, a coinitiator (which may also referred to as a synergist), and other optional ingredients. Such resin systems coupled with unique printing platforms enable volumetric additive manufacturing with fast and precise curing, superior green and final state hardness, tunable strength, modulus, and elongation, and optionally no leachable ingredients.

The photohardenable composition of the present invention may also include blends of different photohardenable resin components.

For example, a blend of different photohardenable resin components may comprise one or more difunctional oligomers, e.g., 20-95 wt % based on the total weight of the polymerizable composition, including vinylesters, vinylcarbonates, methacrylates, and acrylates functionalities; one or more multi-functional (functionality ≥2) reactive diluents, e.g., 1-20 wt % based on the total weight of the polymerizable composition, including methacrylates, acrylates, vinylesters, vinylcarbonate groups.

Examples of difunctional oligomers include difunctional oligomers including a backbone of the polymers bearing urethane, urea, amide, anhydride, bisphenols, epoxies, carbonates, ethers, and esters; difunctional oligomers including optional reactive or blocked functional groups in the backbone, such as hydroxyl, carbonyl, amino, azide, epoxy, isocyanate groups.

Examples of multi-functional reactive diluents include diluents have a functionality of 2, 3, 4, 5, or 6, can be 1,6-hexanediol di(meth)acrylate, di-trimethylolpropane tetraacrylate, 1,3-butanediol di(meth)acrylate, bisphenol A (ethoxylate) di(meth)acrylate, bisphenol A diglycidildi(meth)acrylate, tricyclodecane dimethanol di(meth)acrylate, tricyclodecane dimethanol di(meth)acrylate, ethylene glycol di(meth)acrylate, tripropylene glycol di(meth)acrylate, diethylene glycol di(meth)acrylate, tri(ethylene glycol) divinyl ether, di(ethylene glycol) divinyl ether, N,N′-Methylenebisacrylamide, trimethylolpropane tri(meth)acrylate, Di(trimethylolpropane) tetra(meth)acrylate, pentaerythritol tetra(meth)acrylate, dipentaerythritol penta- or hexa-(meth)acrylate, tris(2-acryloyloxyethyl) Isocyanurate, 1,12-dodecanediol di(meth)acrylate, 1,3-butanediol di(meth)acrylate, poly(ethylene glycol) di(meth)acrylate with a molecular range of 180-1,000 Da, and the mixture thereof.

Examples of compositional ranges for the photohardenable resin component in a photohardenable composition in accordance with the present invention include, but are not limited to, about 10 to 99.9999 parts by weight (based on 100 parts total). The weight percent of the photohardenable resin component can be less than 10 weight percent, e.g., less than five weight percent, less than 3 weight percent, less than 2 weight percent, or one weight percent or less, in some cases such as printing of hydrogels where the remainder of the photohardenable composition is then comprised of non-reactive components that are suspended within the final photohardened resin.

A photohardenable resin component can further include a thixotrope. A thixotrope can be in the form of a solid, a pre-dissolved liquid, or a mixture thereof. Examples of a thixotropes (which may also be referred to herein as rheology modifiers) include, for example and without limitation, urea derivatives; modified urea compounds such as Rheobyk 410, Rheobyk-D 410, Rheobyk D-411, Rheobyk D-415, Rheobyk D-420, Rheobyk 430, and Rheobyk 7410-ET available from BYK-Chemie GmbH, part of the ALTANA Group; fumed metal oxides (also referred to as pyrogenic metal oxides) including for example, but not limited to, fumed silica, fumed alumina; zirconia; precipitated metal oxides including for example, but not limited to, fumed silica, precipitated silica, precipitated alumina; unmodified and organo-modified phyllosilicate clays; dimer and trimer fatty acids; polyether phosphates; oxidized polyolefins; hybrid oxidized polyolefins with polyamide; alkali soluble/swellable emulsions; cellulosic ethers; hydrophobically-modified alkali soluble emulsions; hydrophobically-modified ethylene oxide-based urethane; sucrose benzoate; ester terminated polyamides; tertiary amide terminated polyamides; polyalkyleneoxy terminated polyamides; polyether amides; acrylamidomethyl-substituted cellulose ester polymers; polyethyleneimine; polyurea; organoclays; hydrogenated castor oil; organic base salts of a clay mineral (e.g., montmorillonite) and other silicate-type materials; aluminum, calcium, and zinc salts of fatty acids, such as lauric or stearic acid. When a thixotrope comprising a silica is used, it can be desirable to also include a booster, such as, but not limited to, Rheobyk 405, where booster refers to additives that serve to further increase the thixotropic behavior of a fumed metal oxide. Examples of commercial silicas include, but are not limited to, Aerosil 200, Aerosil 300 and Aerosil 380.

See U.S. Pat. No. 6,548,593 of Merz, et al., issued Apr. 15, 2003, and U.S. Pat. No. 9,376,602 of Walther, et al. issued Jun. 28, 2016, which are hereby incorporated herein by reference in their entireties, for information relating to urea derivatives that may be useful as thixotropes.

Thermally reversible gellants such as ester terminated polyamides, tertiary amide terminated polyamides, polyalkyleneoxy terminated polyamides, and polyether amides, and combinations thereof, may be desirable for us as thixotropes. Examples include Crystasense LP1, Crystasense LP2, Crystasense LP3, Crystasense MP, Crystasense HP4, Crystasense HP5, Rheoptima X17, Rheoptima X24, Rheoptima X38, Rheoptima X58, Rheoptima X73, and Rheoptima X84 available from Croda. Crystasense HP-5 is a preferred example of a thixotrope.

Metal oxides, including, but not limited to, silicas that have been surface-treated to impart dispersibility characteristics compatible with a photohardenable composition described herein may be desirable for use as thixotropes.

A thixotrope or rheology modifier can be included in a photohardenable composition in an amount, for example, in a range from about 0.05 weight percent to about 15 weight percent, from about 0.5 weight percent to about 15 weight percent, from about 0.5 weight percent to about 10 weight percent from about 1 to about 10 weight percent of the composition. Other amounts may also be determined to be useful.

A thixotrope or rheology modifier is preferably included in a photohardenable composition in an amount effective to restrict movement of the three-dimensional object or one or more regions thereof in the photohardenable composition during formation.

More preferably, the thixotrope is included in a photohardenable composition in an amount effective to restrict movement of the three-dimensional object suspended (without contact with a container surface) in the volume of composition during formation. Most preferably the position of the object in the volume of the photohardenable composition remains fixed position during formation of the object.

A photohardenable composition can further include a photoinitiator.

A photoinitiator can be readily selected by one of ordinary skill in the art, taking into account its suitability for the mechanism to be used to initiate polymerization as well as its suitability for and/or compatibility with the photohardenable composition to be polymerized.

Preferred photoiniators for inclusion in a photohardenable composition for use in the present invention include dual wavelength photoinitiators. Dual wavelength photoinitiators possess photochromic properties and can be converted to a second form upon irradiation with light of a first wavelength, which second form can be converted back to the first form upon irradiation with light of a second wavelength or through thermal return to the first form, the process of cycling between these forms under dual color irradiation capable of inducing a crosslinking or polymerization reaction in the photohardenable resin component. The conversion of the photoswitchable photoinitiators described herein to a second form of the molecule (e.g., an isomer thereof) is preferably a reversible photochemical structural change. (Dual wavelength photoinitiators including such photochromic properties are also referred to herein as “photoswitchable photoinitiators”.)

Several considerations in selecting a particular photoswitchable photoinitiator for inclusion in a photohardenable composition or method in accordance with the present invention include, by way of example, but not limited to, the absorption spectra and Amax of the molecule and its second forms, the solubility of the photoswitchable photoinitiator in the photohardenable resin component, the photoinitiation sensitivity of the first and second forms of the photoswitchable photoinitiator, the amount of initial concentration of the second form in the monomer solution, the stability of the photoswitchable photoinitiator and the reduction and oxidation potentials of the first and second form of the photoswitchable photoinitiator.

Preferred photoswitchable photoinitiators include, but are not limited to, photochromic molecules, (e.g., but not limited to, a benzospiropyran molecule, a naphthopyran molecule, a spironaphthoxazine molecule, a diarylethene molecule) which photochromic molecules can more preferably include one or more functional groups attached thereto. Such photochromic molecules can undergo a reversible intramolecular transformation forming a colored form of the molecule by irradiation (photochromic). Such preferred photoswitchable photoinitiators, e.g., in the case of benzospiropyrans, naphthopyrans, and spironaphthoxazines, can function by light activated opening of the photoswitchable photoinitiator to form the colored form upon exposure to a first wavelength. In the case of diarylethenes, the activation process instead involves a ring-closing. The colored form may subsequently absorb light of a different second wavelength which may cause it to revert to the first state. From the first uncolored state it can be excited again to the colored state by the first wavelength, the process of cycling in between these states being capable of subsequently induce photoinitiation, either alone or in combination with a coinitiator (e.g., amine, thiol, organoborate compounds, onium salts).

Photohardenable compositions including a photoswitchable photoinitiator are particularly desirable for use in forming three-dimensional objects in a volume. The photoswitchable photoinitiator molecule in its initial form and the photoinitiator molecule in its colored second form can have sufficiently distinct absorption spectra that once the initial form of the molecule is colored form, the colored form absorbs in a wavelength region where the initial form is minimally absorbing. In this way, the colored form can be independently excited with the second wavelength without causing unintended excitation of the initial form by the second wavelength. The second wavelength can cause more rapid cycling of the photoswitchable photoinitiator than in the presence of the first wavelength alone, this more rapid cycling causing increased rate of radical formation and inducing desired hardening of the photohardenable resin at the intersection of the two colors of light.

Other possible photoinitiator choices include molecules that can undergo two step two color two step absorption, where a first wavelength generates a transient excited state of the molecule, where the transient excited state absorbs at a distinctive wavelength, the absorption of this second state capable of causing photoinitiation.

Information concerning photohardenable compositions, photoswitchable photoinitiators, printing systems, and printing methods that may be useful in connection with the various aspects of the present invention includes International Application No. PCT/US2022/037491, filed Jul. 18, 2022, of Quadratic 3D, Inc., International Application No. PCT/US2022/042179, filed Aug. 31, 2022, of Quadratic 3D, Inc., International Application No. PCT/US2022/042183, filed Aug. 31, 2022, of Quadratic 3D, Inc., International Application No. PCT/US2022/042186, filed Aug. 31, 2022, of Quadratic 3D, Inc., and International Application No. PCT/US2023/022170 of Quadratic 3D, Inc. filed May 13, 2023, each of the foregoing applications being hereby incorporated herein by reference in its entirety.

Additional examples of photoswitchable photoinitiators suitable for inclusion in a photohardenable composition useful in the present invention are described in International Application No. PCT/US2023/022170 of Quadratic 3D, Inc. filed May 13, 2023, and International Application No. PCT/US2023/022173 of Quadratic 3D, Inc. filed May 13, 2023, each of which is hereby incorporated herein by reference in its entirety.

Examples of preferred dual wavelength photoinitiators for use in the methods of the present invention include substituted or unsubstituted P-type photochromic molecules. Examples of such preferred photoinitiators include, but are not limited to, substituted or unsubstituted diarylethene molecules. See, for example, International Application No. PCT/US2023/022172 of Quadratic 3D, Inc. filed May 13, 2023.

Examples of compositional ranges for a dual wavelength photoinitiator in a photohardenable composition in accordance with the present invention include, but are not limited to, about 0.0001 to about 0.5, including, for example, but not limited to, e.g., about 0.0001 to about 0.1, about 0.0001 to about 0.05, about 0.0001 to about 0.01, about 0.0001 to about 0.009, about 0.0001 to about 0.005, from about 0.0001 to about 0.0025, etc.

A photohardenable composition described herein can further optionally include one or more additives. Examples of such optional additives include, but are not limited to, thixotropes, rheology modifiers, a coinitiator, a non-reactive solvent diluent, a second light activated photoinitiator, a filler, a defoamer, a stabilizer, a thermally activated radical initiator, a solvent, a sensitizer, and a colorant.

Additives are preferably selected so that they do not undergo unwanted reactions with other components or additives that may be included in a photohardenable compositions.

A photohardenable composition can optionally include one or more coinitiators. (A coinitiator can also be referred to as a synergist). Optionally, one or more coinitiators can be included.

Inclusion of one or more coinitiators can be desirable when the photoinitiator comprises a dual wavelength or photoswitchable photoinitiator.

Suitable coinitiators include coinitiators which are reducing agents, oxidizing agents, or hydrogen donating compounds.

Examples of coinitiators that may be useful can be selected from among those known in the art and, more particularly, tertiary amines and organoborate salts. Iodonium salts may also be useful, particularly in combination with a borate salt. In certain embodiments, an iodonium salt may also be included in combination with a tertiary amine. Examples of other useful electron donating coinitiators are discussed by Eaton, D. F., “Dye Sensitized Photopolymerization”, Advances in Photochemistry, Vol. 13, pp 427-486.

Representative examples of N,N-dialkylanilines useful in the present invention as coinitiators include 4-cyano-N,N-dimethylaniline, 4-acetyl-N,N-dimethylaniline, 4-bromo-N,N-dimethylaniline, 4-methyl-N,N-dimethylaniline, 4-ethoxy-N,N-dimethylaniline, N,N-dimethylthioanicidine, 4-amino-N,N-dimethylaniline, 3-hydroxy-N,N-dimethylaniline, N,N,N,′N,-tetramethyl-1,4-dianiline, 4-acetamido-N,N-dimethylaniline, 2,6-diethyl-N,N-dimethylaniline, N,N,2,4,6-pentanethylaniline (PMA) and p-t-butyl-N,N-dimethylaniline.

Certain other tertiary amines are also useful coinitiators including triethylamine, triethanolamine, N-methyldiethanolamine, 2-ethyl-4-(dimethylamino)benzoate, 2-ethylhexyl-4-(dimethylamino)benzoate, etc.

Another class of useful coinitiators includes alkyl borate salts such as ammonium salts of borate anions of the formula BR^{a}R^{b}R^{c}R^{d} wherein R^{a}-R^{d} are independently selected from the group consisting of alkyl, aryl, alkaryl, allyl, aralkyl, alkenyl, alkynyl, alicyclic and saturated or unsaturated heterocyclic groups. Representative examples of alkyl groups represented by R^{a}-R^{d} are methyl (Me), ethyl, propyl, butyl, pentyl, hexyl, octyl, stearyl, etc. The alkyl groups may be substituted, for example, by one or more halogen, cyano, acyloxy, acyl, alkoxy or hydroxy groups. Representative examples of aryl groups represented by R^{a}-R^{d} include phenyl, naphthyl and substituted aryl groups such as anisyl and alkaryl such as methylphenyl, dimethylphenyl, etc.

Representative examples of aryl groups represented by R^{a}-R^{d} include benzyl. Representative alicyclic groups include cyclobutyl, cyclopentyl, and cyclohexyl groups. Examples of an alkynyl group aryl propynyl and ethynyl, and examples of alkenyl groups include a vinyl group. Preferably, at least one but not more than three of R^{a}, R^{b}, R^{c}, and R^{d} is an alkyl group. Each of R^{a}, R^{b}, R^{c}, and R^{d} can contain up to 20 carbon atoms, and they typically contain 1 to 7 carbon atoms. More preferably R^{a}-R^{d} are a combination of alkyl group(s) and aryl-group(s) or aralkyl group(s) and still more preferably a combination of three aryl groups and one alkyl group, i.e., an alkyltriphenylborate, e.g., but not limited to, a butyltriphenyl borate.

Additional examples of coinitiators include a curable monomer with (meth)acrylate groups, a cured polymer with tertiary amine groups, a small molecule with tertiary amine groups. Examples include, but are not limited to, Sartomer CN3715US, CN3705, CN374, [2-(dimethylamino)ethyl methacrylate], Allnex Ebecryl P115, [2-ethylhexyl 4-(dimethylamino)benzoate], (2-Mercaptobenzoxazole), N-methyldiethanolamine, triethanolamine, etc.

Examples of compositional ranges for a coinitiator when optionally included in a photohardenable composition in accordance with the present invention include, but are not limited to, about 0.001 to about 10 including, for example, but not limited to, about 0.001 to about 7.5, about 0.001 to about 5, about 0.001 to about 2.5, about 0.001 to about 1, about 0.001 to about 0.5, from about 0.0001 to about 0.25, etc.

Optionally an additive comprising a non-reactive solvent diluent can be included. Examples include, but are not limited to, acetone, amyl acetate, n-butanol, sec-butanol, tert-butanol, butyl acetate, cyclohexanone, decane, dimethylacetamide, dimethylformamide, dimethylsulfoxide, dipropylene glycol, dipropylene glycol methyl ether, ethanol, ethyl acetate, ethylene glycol, glycerol, heptane, isopropanol, isopropyl acetate, methyl ethyl ketone, N-methyl pyrrolidone, propylene carbonate, propylene glycol, propylene glycol diacetate, tetrahydrofuran, tripropylene glygol methyl ether, toluene, water, xylenes.

Optionally a reactive diluent comprising a monofunctional diluents can be included in the photohardenable composition. Examples include, but are not limited to, 1-adamantyl (meth)acrylate, methyl 2-((allyloxy)methyl)acrylate, trimethylolpropane formal (meth)acrylate, isobonyl (meth)acrylate, (hydroxyethyl) (meth)acrylate, 2-hydroxypropyl (meth)acrylate, 4-hydroxybutyl (meth)acrylate, 2-hydroxy-3-phenoxypropyl (meth)acrylate, (2-dimethylaminoethyl) (meth)acrylate, and a mixture thereof. Commercially available examples include, but are not limited to, SR421A(3,3,5 Trimethylcyclohexyl Methacrylate), CTFA ((5-Ethyl-1,3-dioxan-5-yl)methyl Acrylate), and AOMA™ (Methyl 2-(allyloxymethyl)acrylate).

Optionally, a photohardenable composition can further include a second light activated photoinitiator as described in International Application No. PCT/US2023/022171 of Quadratic 3D, Inc., filed 13 May 2023, which is hereby incorporated herein by reference in its entirety. Preferably such photoinitiator is not appreciably responsive to light of a first wavelength or second wavelength. Inclusion of a photoinitiator can be desirable in connection with optional post-processing that includes, for example, a post-curing step involving exposure of the printed object to UV light after printing. Examples include, but are not limited to, Omnirad 184. When a second light activated photoinitator is further included in a photohardenable composition, it can be included, for example, in a compositional range, in part by weight [based on 100 parts total], in a range from about 0.0001 to about 25%, including, for example, but not limited to, about 0.0001 to about 10, about 0.0001 to about 7.5, about 0.0001 to about 5, about 0.0001 to about 2.5, about 0.0001 to about 1, from about 0.0001 to about 0.5, etc.

A photohardenable composition can optionally include one or more fillers, which can include a combination of one or more fillers. A filler can be a polymer, nanoparticle, pre-dissolved/dispersed solution/suspension, and can perform different functions. Examples include halogenated or non-halogenated fire retardants, dispersants, toughener, anti-microbial agents, antioxidants, antistatic agents, lubricants, anti-foam agents, wetting agents, matting agents, colorants dyes, pigments, adhesion promoters, etc.

A filler can be included in an amount greater than 0 to about 90 weight percent, the amount being determined by the purpose for the filler and the desired end use characteristics for the intended three-dimensional object. Advantageously, fillers may be selected to maintain the optical transparency of the photohardenable composition, e.g., by controlling particle size to be substantially less than the excitation wavelengths or by matching the refractive indices of the filler and matrix to reduce optical scatter.

Fillers may be used to modify the properties of a hardened photohardenable composition, for example the stiffness, strength, toughness, impact resistance, resistance to creep, resistance to fatigue, mechanical energy return, mechanical loss tangent, glass transition temperature, thermal degradation temperature, thermal conductivity, thermal resistance, moisture uptake, electrical conductivity, static dissipation, dielectric constant and loss tangent, density, refractive index, optical dispersion, opacity to ionizing radiation, and resistance to ionizing radiation. Fillers may also be used to modify the properties of the liquid (e.g., unhardened) photohardenable composition, such as rheological properties such as viscosity and thixotropy and optical properties such as refractive index. Examples of fillers include but are not limited to silica, alumina, zirconia; silicates glasses such as soda-lime glass, borosilicate glass, sodium silicate glass, lead glass, aluminosilicate glass, barium glass, thorium glass, glass ceramics; chalcogenide glasses; glass microspheres and microbubbles; nanoclays such as laponite, montmorillonite, bentonite, kaolinite, hectorite, and halloysite; calcium phosphate minerals such as hydroxyapatite, mineral fillers such as chalk, rock dust, slag dust, fly ash, hydraulic cement, loess, limestone, kaolin, talc, and wollastonite. Examples of particle size ranges include but are not limited to less than 10 microns, less than 1 micron, 10 nm to 500 nm, 10 nm to 90 nm, 40 nm to 70 nm. Smaller particles sizes, in particular sizes less than about 100 nm, may be beneficial to provide high optical clarity of the liquid composition to better facilitate printing. Controlling the particle size distribution, for example monodisperse, bimodal, or trimodal distributions of sizes, may be beneficial to control rheological properties, increase filler weight percent, or modify the properties of a photohardenable composition.

Another example of an additive that can optionally be included in a photohardenable composition includes defoamers. A defoamer can be included to aid in removing bubbles introduced during processing and handling. A preferred defoamer is BYK 1798 (a silicone based defoamer) available from BYK-Chemie GmbH, part of the ALTANA Group.

Another example of an additive that can optionally be included in a photohardenable composition includes a stabilizer. A stabilizer can be included to improve shelf-life of the composition and/or to control the level of cure and/or spatial resolution during printing. An example of preferred stabilizer is TEMPO (2,2,6,6-tetramethylpiperidinooxy free radical available from Sigma-Aldrich). Examples of other stabilizers include, but are not limited to, hindered phenols such as butylated hydroxytoluene; hydroquinone and its derivatives such as hydroquinone methyl ether; hindered amine light stabilizers; alkylated diphenylamines; and phosphite esters.

Another example of an optional additive includes a thermally activated radical initiator in a photohardenable composition. Thermally activated radical initiator examples include but are not limited to 2,2′-azobis(2-methylpropionitrile), 1,1′-azobis(cyclohexanecarbonitrile), 2,2′-azobis[N-(2-carboxyethyl)-2-methylpropionamidine] n-hydrate, 2,2′-azobis[2-methyl-N-(2-hydroxyethyl)propionamide], organic peroxides, inorganic peroxides, peroxydisulfate salts.

Optionally a solvent, preferably, for example, but not limited to, an acrylamide monomer or an acrylate monomer, can be further included in a composition described herein for mixing the photoswitchable photoinitiator in the photohardenable resin component. Other suitable solvents may also be used.

A photohardenable composition can optionally include one or more sensitizers. Optionally, one or more sensitizers can be included.

A sensitizer can create the excited state of the photoswitchable photoinitiator via absorbing light and transferring energy to the photoswitchable photoinitiator. For example, a sensitizer can control the sensitivity of the composition and extend the spectral sensitivity of the closed form of the photoswitchable photoinitiator. Useful sensitizers include those known in the art such as acetophenone, benzophenone, 2-acetonaphthone, isopropyl thioxanthone, alkoxyketocoumarins, Esacure 3644, and the like.

Examples of compositional ranges for a sensitizer when optionally included in a photohardenable composition in accordance with the present invention include, but are not limited to, about 0.1 to about 0.75, about 0.1 to about 0.5, about 0.1 to about 0.25, etc.

Optionally, a composition described herein can include one or more coinitiators and one or more sensitizers.

Unless otherwise indicated, specified weight percents are based on the total weight of the photohardenable composition.

A photohardenable composition in accordance with the invention can be prepared using known or conventional procedures.

Any component or additive included in a photohardenable composition can be a single component or additive or a mixture of two or more of components or additives.

The selection of a photohardenable resin component, the amount of photoinitiator, and, when applicable, a coinitiator, a thixotrope, and any optional additive(s), included in photohardenable compositions will vary with the particular intended end-use of the part to be printed, the emission characteristics of the exposure sources, the development procedures, the physical properties desired in the hardened product and other factors.

A photohardenable composition preferably displays non-Newtonian rheological behavior. Such rheological behavior can facilitate forming an object in a volume of a photohardenable composition upon exposure to at least two different wavelengths of excitation light wherein the object remains at a fixed position or is minimally displaced in the volume of the unhardened composition during formation. Minimal displacement refers to displacement of the object being formed during its formation in the volume that is acceptable for precisely producing the intended part geometry. Such rheological behavior can also facilitate separation of the partially hardened object from the volume in which it is formed upon application of stress. While not wishing to be bound by theory, upon the application of stress, the apparent viscosity of the non-Newtonian composition can drop to a lower value (e.g., the steady shear viscosity) than the static value (e.g., zero shear viscosity or yield stress) allowing the unhardened composition to more easily flow off and separate from the object. Examples of such non-Newtonian rheological behavior include but are not limited to pseudoplastic fluid, yield pseudoplastic, Bingham plastic, Bingham pseudoplastic rheological behavior.

Non-Newtonian rheological behavior can be imparted to a photohardenable composition by further including one or more reactive components (e.g. urethane acrylate oligomers, urethane methacrylate oligomers, acrylated or methacrylated polyurethanes, acrylated or methacrylated polyurethane-ureas, acrylated or methacrylated polyesters, acrylated or methacrylated polyamides, acrylate- or methacrylate-functional block copolymers, alkenyl- or alkynyl-functional urethane oligomers, alkenyl- or alkynyl-functional polyurethanes, alkenyl- or alkynyl-functional polyurethane-ureas, alkenyl- or alkynyl-functional polyesters, alkenyl- or alkynyl-functional polyamides, alkenyl- or alkynyl-functional block copolymers, thiol-functional urethane oligomers, thiol-functional polyurethanes, thiol-functional polyurethane-ureas, thiol-functional polyesters, thiol-functional polyamides, thiol-functional block copolymers) in the photohardenable resin component and/or by further adding one or more nonreactive additives (e.g., but not limited to, one or more thixotropes and/or rheology modifiers) to the composition. Selection of the one or more of reactive components and the amounts thereof for addition to a photohardenable resin component included in a photohardenable composition to impart non-Newtonian rheological behavior thereto is within the skill of the skilled artisan in the relevant art without undue experimentation. Similarly, selection of nonreactive additives and the amount(s) thereof for addition to the photohardenable composition to impart non-Newtonian rheological behavior thereto is within the skill of the skilled artisan of the relevant art without undue experimentation.

A photohardenable composition described herein can preferably have a steady shear viscosity, for example, which is less than 30,000 centipoise, less than 20,000 centipoise, less than 10,000 centipoise, less than 5,000 centipoise, or less than 1,000 centipoise. (Steady shear viscosity refers to the plateau value of the viscosity achieved with unidirectional constant shear, e.g., the value of the viscosity after the thixotrope network has broken up.) Steady shear viscosities may be measured at ambient (e.g., room temperature), printing temperature, or some other temperature (e.g., elevated or reduced). Measurement at printing temperature may provide advantage in determining the suitability of a photohardenable composition for printing. Preferred steady shear viscosities are less than 30,000 centipoise, more preferably less than 10,000 centipoise, and most preferably less than 1,000 centipoise.

Steady shear viscosity can be measured under continuous constant-rate shear, such as at shear rates ranging from about 0.00001 s⁻¹ to about 1000 s⁻¹.)

A printing resin or photohardenable composition included in the methods described herein preferably includes a photohardenable resin component and a dual wavelength photoinitiator.

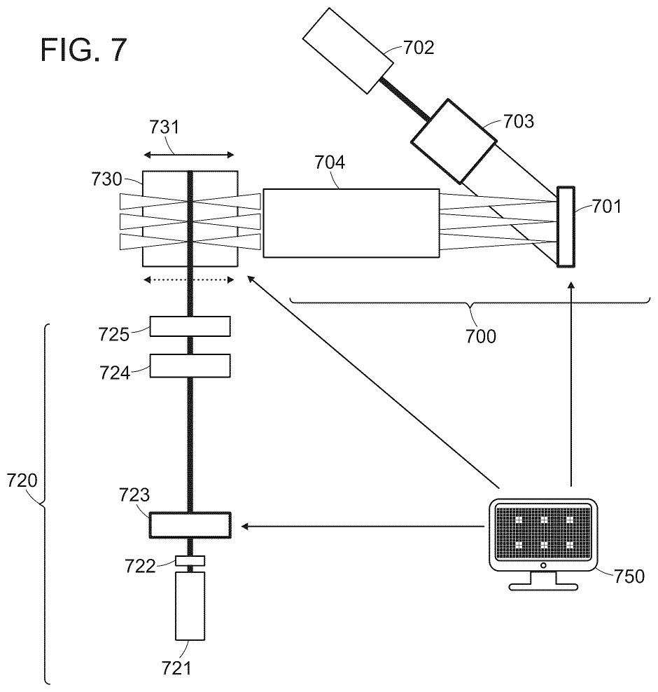

FIG. 7 illustrates a side view of a schematic of system for use in the methods and systems described herein including a light sheet generating system described herein.

In the example of the depicted figure, the system includes a light sheet generating system 720 and optical projection system 700 positioned such that the light sheet generating system generates and directs a light sheet to a selected location in a volume of a photohardenable composition included in a container 730 and the optical projection system generates and projects a scaled digital slice of an optical image to the selected location in the volume at which the light sheet and scaled digital slice of the optical image intersect or overlap and include a polymerization or cross-linking reaction for at least partially forming a two dimensional cross-sectional slice of the object to be printed. The optical projection system 700 includes a projection device (e.g., a DMD) 701 and a light source 702 in combination with illumination optics 703 to illuminate the DMD. Such illumination optics can optionally comprise beam conditioning and condenser optics and relay optics. A light source for a second excitation light including a second wavelength illuminates the projection device. A light source comprising a non-pulsed laser or a continuous wave laser can be preferred. In the depicted example, projection optics 704 are positioned between the DMD and a container (not shown). Projection optics can be used for magnifying and projecting a focused an optical projection of excitation light comprising a two-dimensional image into the container. Optionally, prism(s) (not shown) can be positioned between the DMD 701 and the projection optics 704. In the depicted example, an optical image (typically a 2-dimensional cross-section slice of the object to be printed) is projected to the selected focal plane at the selected location in the volume. The optical image is orthogonal to the direction in which it is projected into the volume.

The example of the depicted light sheet generating system 720 includes a light source 721 of a first excitation light including a first wavelength, preferably a laser, from which a light sheet is generated by a light sheet generating optics 722, the light sheet including two major parallel faces that are parallel to the direction in which the light sheet is directed to a selected location in the volume. The light sheet generating system 720 can also preferably include a scanner 723 and a first optical element including an aspherical surface 724 and a second optical element can comprise, for example, a spherical surface 725 between the scanner and the container. More preferably the aspherical surface of the first optical element and spherical surface of the second optical element face each other.

Preferably the directions in which the light sheet and optical image are directed to the selected location in the volume are orthogonal to each other with the optical image and light sheet intersecting or overlapping in a coplanar manner.

A computer 750 is also shown. The computer 750 can include a processor, memory, and interfaces such as a network interface or a Universal Serial Bus (USB) interface. The processor can be one or multiple processors, which can each include multiple processor cores. The memory can include volatile memory such as Random Access Memory (RAM). The memory can include non-volatile memory such as flash memory or read-only memory (ROM). The computer can include one or more types of computer storage media and devices, which can include the memory to store instructions of programs that run on the processor. For example, a 3D printing program can be stored in the memory and run on the processor to implement the techniques described herein. In some implementations, the controller can include the 3D printing program.

The 3D printing program can include a slicing program for transforming a digital model into a sequence of layers that collectively form the structure when projected onto the photohardenable composition on the selected timescale and at the selected speed. The slicing program can access a file containing mesh or another kind of 3D part data that represents a digital model. The slicing program can map the digital model to a discrete array of pixels. In some implementations, for example, the digital model can be sliced into grids of pixels.

The 3D printing program, the controller, or both can implement methods of the invention including assignment of intensity levels to pixels in the optical image to generate and use a scaled digital slide based on one or more factors including its position in the arrangement relative to one or more propagating rays of the first excitation light to which the pixel will be exposed during printing of the scaled digital slice. The light intensity levels can range from 100% (e.g., for any “on” pixel assigned maximum brightness to zero for an “off” (or non-illuminated) pixel, and multiple brightness levels therebetween corresponding to the assigned intensity level. Based on the assigned intensity levels, the 3D printing program, the controller, or both can output layer information, such as graphic files or light modulation command sequences, that represent respective patterns of light to be generated for each scaled digital slice of the object to be printed.

Software can be used to coordinate generation of the scaled digital slices from the projector device, preferably a spatial light modulator, so that the part is developed plane by plane along the dimension with respect to which the 3D object file is sliced. Selection of computer controls and software is within the skill of the person of ordinary skill in the relevant art.

There are a variety of optical modulators that can provide patterned light of controllable intensity. For example, a ray from a laser can be scanned or steered to create patterns on a surface, and the laser's intensity can be varied during the spot's movement. There are also two-dimensional spatial light modulators (SLMs) which can impart two-dimensional patterns on light. These include liquid crystal modulators that are capable of a variety of modulation ratios between “on” and “off” as well as binary SLMs such as micromirror arrays that principally have only two states: on and off. In the latter case, a variable intensity can be effectively achieved in several ways. In one way, the binary SLM can use in-plane dithering, such as Floyd-Steinberg dithering, to achieve a range of intensities when considered in a locally-averaged basis. Another way for binary SLMs to provide a range of intensities is through flickering, in which the ratio of on-to-off states of a pixel over a time-averaging window provides an approximation to a desired intensity.

As depicted in FIG. 7, the optical projection system comprises a DMD. Other spatial light modulator (e.g., an LCOS, LCD, or μLED) can alternatively be included in a projection system).

The example of the system depicted in FIG. 7 also includes a light sheet generating system 720 for generating a plane of light or light sheet and directing the light sheet to a selected location in the volume. The major face of the plane of light or light sheet is preferably orthogonal or substantially orthogonal to the projection axis of the optical image such that the light sheet and optical image intersect or overlap in a plane at the selected location in the volume. The light sheet generating system includes a light source 721 which directs through an optical arrangement (that can include, for example, a light sheet generator 722 and light sheet optics 723) for generating and directing a light sheet into the container 730.

An example of a light sheet generating system can include a light source 721 which directs collimated light through an optical arrangement for generating the light sheet which can include a light sheet generator 722 that can include a Powell lens (not shown), and light sheet optics 723 including, for example, one or more cylindrical lens, for directing the light sheet into the container 730. An example of a collimated light source is a free space non-pulsed laser. Light sheet optics including other different numbers and/or types of lenses may also be determined by the skilled artisan to be suitable. The use of cylinder lenses can be preferred as this permits independent shaping of the light distribution in orthogonal directions. Examples of cylindrical lenses include off the shelf plano convex cylindrical lenses with focal lengths in the range 25 mm-250 mm, available from Thorlabs.

Optionally, a galvanometer, polygon scanner, MEMS scanner, diffractive optical elements, cylindrical lenses, or axicon lenses, with or without additional optical components, can be included in place of the Powell lens.

Other systems and configurations for generating and directing a light sheet to a selected location in the volume can be used.

Light sources included in the system are preferably selected taking into consideration the photohardenable liquid being used and the hardening mechanism therefor. Such considerations include the wavelength(s) preferred for the particular photohardening mechanism and power levels preferred therefor. Selection of suitable light sources is within the skill of the person of ordinary skill in the relevant art.

As discussed above, a light sheet system can optionally include compression for decreasing the height of the light sheet as it passes through the volume or defocusing for increasing the height of the light sheet as it passes through the volume.

As also mentioned above, a system can optionally be configured to generate and direct light sheets into the volume from opposite sides of the volume to overlap with each other in the volume and further intersect or overlap with the optical image.

While the figures depict examples of systems including a container, optionally the container can be included as a component of a system or separately provided for inclusion prior to use.

Optionally any light source can be included as component of a light sheet generating system or optical image projection system or can be separately supplied for use therewith.

Embodiments of the invention include the following:

### Embodiment 1

A method for generating a light sheet having a height with a profile of power along its height and a profile of thickness along its height for producing substantial cure uniformity in a photohardenable composition along the light sheet height, the method comprising:
a. generating a light sheet with a light sheet generator including a light source for generating a first light and one or more light sheet generating optical elements for shaping the first light into a light sheet with an as-generated power profile along its height and an as-generated thickness profile along its height and having a propagation direction, and
b. directing the as-generated light sheet through a light sheet input side of an optical system including the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is substantially uniform over the height of the light sheet, and the as-generated light sheet thickness profile at the light sheet input side to a light sheet output thickness profile at the light sheet output side that is substantially uniform over the light sheet height such that the cure along height is substantially uniform.

### Embodiment 2

A method for generating a light sheet having a height with a profile of power along its height and a profile of thickness along its height for producing substantial cure uniformity in a photohardenable composition along the light sheet height, the method comprising:
a. generating a light sheet with a light sheet generator including a light source for generating a first light and one or more light sheet generating optical elements for shaping the first light into a light sheet with an as-generated power profile along its height and an as-generated thickness profile along its height and having a propagation direction,
b. directing the as-generated light sheet through a light sheet input side of an optical system including the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is substantially uniform over the height of the light sheet, and the as-generated light sheet thickness profile at the light sheet input side to a light sheet output thickness profile at the light sheet output side that is substantially uniform over the light sheet height such that the cure along height is substantially uniform, and
c. directing the light sheet output of the optical system into a container of a photohardenable composition, the photohardenable composition having a known absorptivity value for the light sheet wavelength, wherein the light rays included in the light sheet output from the optical system have an angular distribution such that the uniformity of the power along the light sheet height is maintained throughout the depth of the photohardenable composition, wherein the aspherical surface generates such profile without spherical aberrations that are unavoidable in a system using a spherical surface in place of the aspherical surface.

### Embodiment 3

A system for generating a light sheet having a height with a profile of power along its height and a profile of thickness along its height for producing substantial cure uniformity in a photohardenable composition along the light sheet height, the system comprising:
a light sheet generator including a light source for generating a first light and one or more light sheet generating optical elements for shaping the first light into a light sheet with an as-generated power profile along its height and an as-generated thickness profile along its height and having a propagation direction,
an optical system including a light sheet input side and a light sheet output side, wherein the optical system comprises one or more optical elements at least one of which has an aspherical surface for converting the as-generated light sheet height power profile at the light sheet input side to a light sheet height power profile at the light sheet output side that is substantially uniform over the height of the light sheet, and the as-generated light sheet thickness profile at the light sheet input side to a light sheet output thickness profile at the light sheet output side that is substantially uniform over the light sheet height such that the cure along height is substantially uniform.

### Embodiment 4

A method for generating a light sheet having a height with a profile of power along its height and a profile of thickness along its height for producing substantial cure uniformity in a photohardenable composition along the light sheet height, the method comprising:
a. generating a light sheet with a light sheet generator including a light source for generating a first light and one or more light sheet generating optical elements for shaping the first light into a light sheet with an as-generated power profile along its height and an as-generated thickness profile along its height and having a propagation direction, and
b. directing the as-generated light sheet through a light sheet input side of an optical system including the light sheet input side and a light sheet output side, wherein the optical system includes the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is non-uniform over the height of the light sheet, and the as-generated light sheet thickness profile at the light sheet input side to a light sheet output thickness profile at the light sheet output side that is non-uniform over the light sheet height such that the cure along height is substantially uniform.

### Embodiment 5

A method for generating a light sheet having a height with a profile of power along its height and a profile of thickness along its height for producing substantial cure uniformity in a photohardenable composition along the light sheet height, the method comprising:
a. generating a light sheet with a light sheet generator including a light source for generating a first light and one or more light sheet generating optical elements for shaping the first light into a light sheet with an as-generated power profile along its height and an as-generated thickness profile along its height and having a propagation direction,
b. directing the as-generated light sheet through a light sheet input side of an optical system including the light sheet input side and a light sheet output side, wherein the optical system includes the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is non-uniform over the height of the light sheet, and the as-generated light sheet thickness profile at the light sheet input side to a light sheet output thickness profile at the light sheet output side that is non-uniform over the light sheet height such that the cure along height is substantially uniform, and
c. directing the light sheet output of the optical system into a container of a photohardenable composition, the photohardenable composition having a known absorptivity value for the light sheet wavelength, wherein the light rays included in the light sheet output from the optical system have an angular distribution such that the uniformity of the power along the light sheet height is maintained throughout the depth of the photohardenable composition, wherein the aspherical surface generates such profile without spherical aberrations that are unavoidable in a system using a spherical surface in place of the aspherical surface.

### Embodiment 6

A system for generating a light sheet having a height with a profile of power along its height and a profile of thickness along its height for producing substantial cure uniformity in a photohardenable composition along the light sheet height, the system comprising:
a light sheet generator including a light source for generating a first light and one or more light sheet generating optical elements for shaping the first light into a light sheet with an as-generated power profile along its height and an as-generated thickness profile along its height and having a propagation direction,
an optical system including a light sheet input side and a light sheet output side, wherein the optical system comprises one or more optical elements at least one of which has an aspherical surface for converting the as-generated light sheet height power profile at the light sheet input side to a light sheet height power profile at the light sheet output side that is non-uniform over the height of the light sheet, and the as-generated light sheet thickness profile at the light sheet input side to a light sheet output thickness profile at the light sheet output side that is non-uniform over the light sheet height such that the cure along height is substantially uniform.

### Embodiment 7

A method of forming one or more objects in a volume of a photohardenable composition, the method comprising: (a) providing a volume of the photohardenable composition included within a container wherein at least a portion of the container is optically transparent so that the photohardenable composition is accessible by excitation light; (b) directing a light sheet generated by a method for generating a light sheet described herein to one or more selected locations in the volume of the photohardenable composition, and projection of an optical image to the one or more selected locations in the volume of the photohardenable composition to alter at least one property of the photohardenable composition at an intersection of the light sheet and projected optical image at a selected location to induce a crosslinking or polymerization reaction in the photohardenable composition.

### Embodiment 8

A system for printing one or more three-dimensional objects in a volume of a photohardenable composition, the system comprising:
a first optical system comprising a system for generating a light sheet having a height with a profile of power along its height and a profile of thickness along its height described herein, the first optical system being configurable for directing the light sheet to one or more selected locations in the volume of the photohardenable composition contained in a container position in the system; and
a second optical system including a second excitation light source, a spatial light modulator and one or more optical elements for illuminating the spatial light modulator and projecting a selected optical image to the one or more selected locations in the volume.

### Embodiment 9

A method for generating a light sheet having a height with a profile of power along its height and a profile of light sheet thickness along its height for producing substantial cure uniformity in a photohardenable composition along the light sheet height as it traverses through a volume of the photohardenable composition, the method comprising:
a. generating a light sheet from a light sheet generator including a light source for generating a first wavelength and one or more light sheet generating optical elements including a scanner for shaping the first light into a light sheet including diverging light rays.
b. directing the as-generated light sheet including the diverging light rays though an optical system having a light sheet input side and a light sheet output side, wherein the optical system comprises one or more optical elements at least one of which has an aspherical surface designed for converting the diverging light rays into a converging ray fan that provides a light sheet output with absorption compensation as it traverses through the volume of the photohardenable composition for achieving substantially uniform cure along the height of the light sheet along its traversal path through the volume.

### Embodiment 10

The method of Embodiment 9 wherein the profile of power along the light sheet output and the profile of light sheet thickness along the height of the light sheet output are substantially uniform along the height of the light sheet output as it traverses the volume of the photohardenable composition.

### Embodiment 11

A method for generating a light sheet having a height with a profile of power along its height and a profile of light sheet thickness along its height for producing substantial cure uniformity in a photohardenable composition along the light sheet height as it traverses through a volume of the photohardenable composition, the method comprising:
a. generating a light sheet from a light sheet generator including a light source for generating a first wavelength and one or more light sheet generating optical elements for shaping the first light into a light sheet including diverging light rays.
b. directing the as-generated light sheet including the diverging light rays though an optical system having a light sheet input side and a light sheet output side, wherein the optical system comprises one or more optical elements at least one of which has an aspherical surface designed for converting the diverging light rays into a converging ray fan that provides a light sheet output with absorption compensation as it traverses through the volume of the photohardenable composition for achieving substantially uniform cure along the height of the light sheet along its traversal path through the volume.

### Embodiment 12

The method of Embodiment 11 wherein the profile of power along the light sheet output and the profile of light sheet thickness along the height of the light sheet output are substantially uniform along the height of the light sheet output as it traverses the volume of the photohardenable composition.

### Embodiment 13

The method of Embodiment 11 further including directing the light sheet output of the optical system into a container including the volume of a photocurable resin, the container having a length, width, and height, wherein the light sheet output is directed into the container along the width dimension of the container, the resin having a known absorptivity value for the light sheet wavelength, wherein the converging light rays included in the light sheet output from the optical system have an angular distribution such that the uniformity of the power profile along the light sheet height is maintained as the light sheet output traverses the photohardenable composition along the width dimension of the container.

### Embodiment 14

The method of Embodiment 12 further including directing the light sheet output of the optical system into a container including the volume of a photocurable resin, the container having a length, width, and height, wherein the light sheet output is directed into the container along the width dimension of the container, the resin having a known absorptivity value for the light sheet wavelength, wherein the converging light rays included in the light sheet output from the optical system have an angular distribution such that the uniformity of the power profile along the light sheet height is maintained as the light sheet output traverses the photohardenable composition along the width dimension of the container.

### Embodiment 15

The method of Embodiment 13 wherein the angular distribution of the light rays included in the light sheet output of the optical system counter the absorption of the first wavelength as the light sheet traverses the volume of the photohardenable composition in the container.

### Embodiment 16

The method of Embodiment 14 wherein the angular distribution of the light rays included in the light sheet output of the optical system counter the absorption of the first wavelength as the light sheet traverses the volume of the photohardenable composition in the container.

### Embodiment 17

The method of Embodiment 13 wherein the design of the aspherical surface generates a substantially unform light sheet output power profile without spherical aberrations that are unavoidable in a system using a spherical surface in place of the aspherical surface.

### Embodiment 18

The method of Embodiment 14 wherein the design of the aspherical surface generates a substantially unform light sheet output power profile without spherical aberrations that are unavoidable in a system using a spherical surface in place of the aspherical surface.

### Embodiment 19

The method of Embodiment 11 wherein the photohardenable composition includes a photohardenable component and a dual wavelength photoinitiator.

### Embodiment 20

The method of Embodiment 11 wherein the photohardenable composition includes a photohardenable component and a dual wavelength photoinitiator.

### Embodiment 21

The method of Embodiment 1 wherein the one or more optical elements include a first optical element including the aspherical surface and a second optical element including a spherical surface.

### Embodiment 22

The method of Embodiment 21 wherein the aspherical surface and the spherical surface face each other.

### Embodiment 23

The method of Embodiment 22 wherein the as-generated light passes through the optical element including the aspherical surface for passing through the optical element including the spherical surface.

### Embodiment 24

A method of forming one or more objects in a volume of a photohardenable composition, the method comprising: (a) providing a volume of the photohardenable composition included within a container wherein at least a portion of the container is optically transparent so that the photohardenable composition is accessible by excitation light; (b) directing a light sheet generated by the method of Embodiment 11 to a selected location in the volume of the photohardenable composition and a projection of an optical image including a second wavelength to the selected location in the volume of the photohardenable composition to alter at least one property of the photohardenable composition at an intersection of the light sheet and projected optical image at the selected location to induce a crosslinking or polymerization reaction in the photohardenable composition.

### Embodiment 25

The method of Embodiment 24 wherein the light sheet output directed into the volume of the photohardenable composition includes light rays having an angular distribution such that substantial uniformity of the power profile along the light sheet height is maintained as the light sheet output traverses the photohardenable composition.

### Embodiment 26

The method of Embodiment 24 further including repeating step (b) on or more times, until one or more three-dimensional object is partially or fully formed, wherein, for a repeated step (b), the selected location is the same as or different from a previous selected location and/or the optical image is the same as or different from a previous optical image.

### Embodiment 27

The method of Embodiment 24 wherein the photohardenable composition includes a photohardenable component and a photoinitiator.

### Embodiment 28

The method of Embodiment 24 wherein the photohardenable composition includes a photohardenable component and a dual wavelength photoinitiator and the first and second wavelengths are different.

### Embodiment 29

The method of Embodiment 9 further including directing the light sheet output of the optical system into a container including the volume of a photocurable resin, the container having a length, width, and height, wherein the light sheet output is directed into the container along the width dimension of the container, the photohardenable composition having a known absorptivity value for the light sheet wavelength, wherein the converging light rays included in the light sheet output from the optical system have an angular distribution such that the uniformity of the power profile along the light sheet height is maintained as the light sheet output traverses the photohardenable composition along the width dimension of the container.

As used herein, the singular of “a”, “an”, and “the” include plural unless the context clearly dictates otherwise. Thus, for example, reference to a photoinitiator includes reference to one or more photoinitiators.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the present invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method for generating a light sheet having a height with a profile of power along its height and a profile of light sheet thickness along its height for producing substantial cure uniformity in a photohardenable composition along the light sheet height as it traverses through a volume of the photohardenable composition, the method comprising:
a. generating a light sheet from a light sheet generator including a light source for generating a first wavelength and one or more light sheet generating optical elements for shaping the first light into a light sheet including diverging light rays.
b. directing the as-generated light sheet including the diverging light rays though an optical system having a light sheet input side and a light sheet output side, wherein the optical system comprises one or more optical elements at least one of which has an aspherical surface designed for converting the diverging light rays into a converging ray fan that provides a light sheet output with absorption compensation as it traverses through the volume of the photohardenable composition for achieving substantially uniform cure along the height of the light sheet along its traversal path through the volume.

2. The method of claim 1 wherein the profile of power along the light sheet output and the profile of light sheet thickness along the height of the light sheet output are substantially uniform along the height of the light sheet output as it traverses the volume of the photohardenable composition.

3. The method of claim 1 further including directing the light sheet output of the optical system into a container including the volume of a photocurable resin, the container having a length, width, and height, wherein the light sheet output is directed into the container along the width dimension of the container, the resin having a known absorptivity value for the light sheet wavelength, wherein the converging light rays included in the light sheet output from the optical system have an angular distribution such that the uniformity of the power profile along the light sheet height is maintained as the light sheet output traverses the photohardenable composition along the width dimension of the container.

4. The method of claim 2 further including directing the light sheet output of the optical system into a container including the volume of a photocurable resin, the container having a length, width, and height, wherein the light sheet output is directed into the container along the width dimension of the container, the resin having a known absorptivity value for the light sheet wavelength, wherein the converging light rays included in the light sheet output from the optical system have an angular distribution such that the uniformity of the power profile along the light sheet height is maintained as the light sheet output traverses the photohardenable composition along the width dimension of the container.

5. The method of claim 3 wherein the angular distribution of the light rays included in the light sheet output of the optical system counter the absorption of the first wavelength as the light sheet traverses the volume of the photohardenable composition in the container.

6. The method of claim 4 wherein the angular distribution of the light rays included in the light sheet output of the optical system counter the absorption of the first wavelength as the light sheet traverses the volume of the photohardenable composition in the container.

7. The method of claim 3 wherein the design of the aspherical surface generates a substantially unform light sheet output power profile without spherical aberrations that are unavoidable in a system using a spherical surface in place of the aspherical surface.

8. The method of claim 4 wherein the design of the aspherical surface generates a substantially unform light sheet output power profile without spherical aberrations that are unavoidable in a system using a spherical surface in place of the aspherical surface.

9. The method of claim 1 wherein the photohardenable composition includes a photohardenable component and a dual wavelength photoinitiator.

10. The method of claim 1 wherein the photohardenable composition includes a photohardenable component and a dual wavelength photoinitiator.

11. The method of claim 1 wherein the one or more optical elements include a first optical element including the aspherical surface and a second optical element including a spherical surface.

12. The method of claim 11 wherein the aspherical surface and the spherical surface face each other.

13. The method of claim 12 wherein the as-generated light passes through the optical element including the aspherical surface for passing through the optical element including the spherical surface.

14. A method for generating a light sheet having a height with a profile of power along its height and a profile of thickness along its height throughout the width of the for producing substantial cure uniformity in a photohardenable composition along the light sheet height, the method comprising:
a. generating a light sheet with a light sheet generator including a light source for generating a first wavelength and one or more light sheet generating optical elements for shaping the first light into a light sheet including light rays with an as-generated power profile along its height and an as-generated thickness profile along its height and having a propagation direction, and
b. directing the as-generated light sheet through a light sheet input side of an optical system including the light sheet input side and a light sheet output side, wherein the optical system comprises one or more optical elements at least one of which has an aspherical surface for converting the as-generated light sheet height power profile at the light sheet input side to a light sheet height power profile at the light sheet output side that is substantially uniform over the height of the light sheet, and the as-generated light sheet thickness profile at the light sheet input side to a light sheet output thickness profile at the light sheet output side that is substantially uniform over the light sheet height such that the cure along height is substantially uniform.

15. The method of claim 14 further including:
c. directing the light sheet output of the optical system into a container of a photohardenable composition, the resin having a known absorptivity value for the light sheet wavelength, wherein the light rays included in the light sheet output from the optical system have an angular distribution such that the uniformity of the power profile along the light sheet height is maintained throughout the depth of the resin, wherein the aspherical surface generates such profile without spherical aberrations that are unavoidable in a system using a spherical surface in place of the aspherical surface.

16. A method of forming one or more objects in a volume of a photohardenable composition, the method comprising: (a) providing a volume of the photohardenable composition included within a container wherein at least a portion of the container is optically transparent so that the photohardenable composition is accessible by excitation light; (b) directing a light sheet generated by the method of claim 1 to a selected location in the volume of the photohardenable composition and a projection of an optical image including a second wavelength to the selected location in the volume of the photohardenable composition to alter at least one property of the photohardenable composition at an intersection of the light sheet and projected optical image at the selected location to induce a crosslinking or polymerization reaction in the photohardenable composition.

17. The method of claim 16 wherein the light sheet output directed into the volume of the photohardenable composition includes light rays having an angular distribution such that substantial uniformity of the power profile along the light sheet height is maintained as the light sheet output traverses the photohardenable composition.

18. The method of claim 16 further including repeating step (b) on or more times, until one or more three-dimensional object is partially or fully formed, wherein, for a repeated step (b), the selected location is the same as or different from a previous selected location and/or the optical image is the same as or different from a previous optical image.

19. The method of claim 16 wherein the photohardenable composition includes a photohardenable component and a photoinitiator.

20. The method of claim 16 wherein the photohardenable composition includes a photohardenable component and a dual wavelength photoinitiator and the first and second wavelengths are different.
